(19) United States
(12) Patent Application Publication
(10) Pub. No.: US 2023/0254209 A1
(43) Pub. Date: Aug. 10, 2023

(54) CONFIGURATION METHOD, TERMINAL, SERVICE TERMINAL AND CONFIGURATION SYSTEM

(71) Applicant: ZTE Corporation, Shenzhen (CN)

(72) Inventor: Jian YUAN, Shenzhen (CN)

(21) Appl. No.: 18/013,419

(22) PCT Filed: Jun. 24, 2021
(86) PCT No.: PCT/CN2021/102143

§ 371 Date: Dec. 28, 2022

(30) Foreign Application Priority Data
Jun. 29, 2020 (CN) 202010606440.7

(51) Int. Cl. H04L 41/0866; H04W 24/06; H04L 41/0816

(52) U.S. Cl. CPC H04L 41/0866; H04W 24/06; H04L 41/0816

(57) ABSTRACT

Provided area configuration method, a terminal, a server side and a configuration system. The method includes: receiving a configuration message; parsing the configuration message to obtain a parameter description of the configuration message; and refusing configuration according to the configuration message if the parameter description does not conform to a pre-defined parameter description. Namely, after the configuration message is received, whether the parameter description of the configuration message is a standard parameter description is parsed and determined so as to determine whether the configuration message is in a standard command format or not, if not, executing the configuration message can be refused, and thus, a problem that there is no solution about how to process non-standard commands for the terminal in the related technologies, and the non-standard commands possibly causes abnormality of the terminal can be solved, thereby achieving a technical effect of preventing abnormality of the terminal.

### CROSS-REFERENCE TO RELATED APPLICATION

The present disclosure claims priority to Chinese Patent Application No. CN202010606440.7, filed on Jun. 29, 2020, and entitled “Configuration method, terminal, server side and configuration system”, the disclosure of which is hereby incorporated by reference in its entirety.

### TECHNICAL FIELD

The embodiments of the present disclosure relates to the field of communication, in particular to a configuration method, a terminal, a server side and a configuration system.

### BACKGROUND

In related technologies, Open Mobile Alliance Client Provisioning (OMACP) serves as a standard protocol, which defines how a server interacts with a terminal. But, when the server interacts with the terminal under the protocol, the terminal can only process standard commands issued by a server side, there is no solution about how to process non-standard commands in the related technologies, and the non-standard commands may possibly cause the terminal being abnormal.

### SUMMARY

The embodiment of the present disclosure provides a configuration method, a terminal, a server side and a configuration system so as to at least solve a problem that there is no solution about how to process non-standard commands for the terminal in the related technologies, which causes abnormality of the terminal.

An embodiment of the present disclosure provides a configuration method applied to a terminal, comprising:

receiving a configuration message; parsing the configuration message to obtain a parameter description of the configuration message, wherein the parameter description is at least used for indicating the configuration message and comprises a parameter type and parameter value; and refusing executing configuration according to the configuration message upon a condition that the parameter description does not conform to a pre-defined parameter description which is used for indicating a pre-defined parameter value range of the parameter type.

In an embodiment, after the configuration message is received, the method further comprises: executing configuration according to the configuration message; and re-executing the configuration according to a pre-defined default parameter description if a terminal enters an abnormal state after configuration, where the default parameter description comprises a default parameter type and a default parameter value.

In an embodiment, the method further comprises: discarding a configuration message upon a condition that a parameter description conforms to a pre-defined error parameter description.

In an embodiment, a configuration message is an OMACP message.

Another embodiment of the present disclosure provides a configuration method applied to a server side, comprising:

sending a configuration message, where the configuration message is used for instructing a terminal to parse the same so as to obtain a parameter description of the configuration message, the parameter description is at least used for indicating the configuration message and comprises a parameter type and parameter value, and the configuration message is further used for instructing the terminal to refuse configuration according to the configuration message if the parameter description does not conform to a pre-defined parameter description used for indicating a pre-defined parameter value range of the parameter type.

In an embodiment, a configuration message is further used for instructing a terminal to execute configuration according to the configuration message after the configuration message is received; and configuration is executed again according to a pre-defined default parameter description if the terminal enters an abnormal state after configuration, where the default parameter description comprises a default parameter type and default parameter value.

In an embodiment, a configuration message is further used for instructing a terminal to abandon the configuration message if a parameter description conforms to a pre-defined error parameter description.

In an embodiment, the sending a configuration message comprises: sending the configuration message to a terminal, or sending the configuration message to a proxy gateway so as to instruct the proxy gateway to forward the configuration message to the terminal.

Another embodiment of the present disclosure provides a terminal, comprising:

a Receiving module configured to receive a configuration message;

an parsing module configured to parse the configuration message to obtain a parameter description of the configuration message, where the parameter description is at least used for indicating the configuration message and comprises a parameter type and parameter value; and

an Execution module configured to refuse configuration according to the configuration message if the parameter description does not conform to a pre-defined parameter description which is used for indicating a pre-defined parameter value range of the parameter type.

Another embodiment of the present disclosure provides a server side. The server side comprises: a sending module configured to send a configuration message used for instructing a terminal to parse the same so as to obtain a parameter description of the configuration message, where the parameter description is at least used for indicating the configuration message and comprises a parameter type and parameter value; and the configuration message is further used for instructing the terminal to refuse configuration according to the configuration message if the parameter description does not conform to a pre-defined parameter description used for indicating a pre-defined parameter value range of the parameter type.

Another embodiment of the present disclosure provides a configuration system, comprising:

a server side and a terminal, where, the server side is configured to send a configuration message;

the terminal is configured to receive the configuration message;

the terminal is further configured to parse the configuration message to obtain a parameter description of the configuration message, where the parameter description is at least used for indicating the configuration message and comprises a parameter type and parameter value; and

the terminal is further configured to refuse configuration according to the configuration message if the parameter description does not conform to a pre-defined parameter description which is used for indicating a pre-defined parameter value range of the parameter type.

Another embodiment of the present disclosure further provides a computer-readable storage medium storing computer programs, where the computer programs are configured to execute steps in any above method embodiment during operation.

Another embodiment of the present disclosure further provides an electronic device, comprising a memory and a processor. The memory stores computer programs, and the processor is configured to operate the computer programs so as to execute steps in any above method embodiment.

In the embodiment of the present disclosure, the configuration message is received and parsed to obtain the parameter description of the configuration message, where the parameter description is at least used for indicating the configuration message and comprises the parameter type and the parameter value; and configuration according to the configuration message is refused if the parameter description does not conform to the pre-defined parameter description, where the pre-defined parameter description is used for indicating the pre-defined parameter value range of the parameter type. Namely, after the configuration message is received, whether the parameter description of the configuration message is a standard parameter description or not is parsed and determined so as to determine whether the configuration message is in a standard command format or not, if not, executing the configuration message can be refused, and thus, a problem that there is no solution about how to process non-standard commands for the terminal in the related technologies, and the non-standard commands possibly cause abnormality of the terminal can be solved, thereby achieving a technical effect of preventing abnormality of the terminal.

### BRIEF DESCRIPTION OF THE DRAWINGS

FIG. 1 is a hardware structure diagram of a mobile terminal of a configuration method according to an embodiment of the present disclosure;

FIG. 2 is a flowchart of a configuration method according to an embodiment of the present disclosure;

FIG. 3 is a flowchart of a configuration method according to another embodiment of the present disclosure;

FIG. 4 is a structure diagram of a terminal according to an embodiment of the present disclosure;

FIG. 5 is a structure diagram of a server side according to an embodiment of the present disclosure;

FIG. 6 is a structure diagram of a configuration system according to an exemplary implementation mode of the present disclosure;

FIG. 7 is a structure diagram of server side and terminal interaction according to an exemplary implementation mode of the present disclosure; and

FIG. 8 is a schematic flowchart of a configuration method according to an exemplary implementation mode of the present disclosure.

### DETAILED DESCRIPTION OF THE EMBODIMENTS

Embodiments of the present disclosure are described in detail by referring to drawings and combining embodiments as below.

It needs to be explained that terms such as “first” and “second” in Description and Claims of the present disclosure and the above drawings are used for distinguishing similar objects but not necessarily used for describing specific sequences or precedence orders.

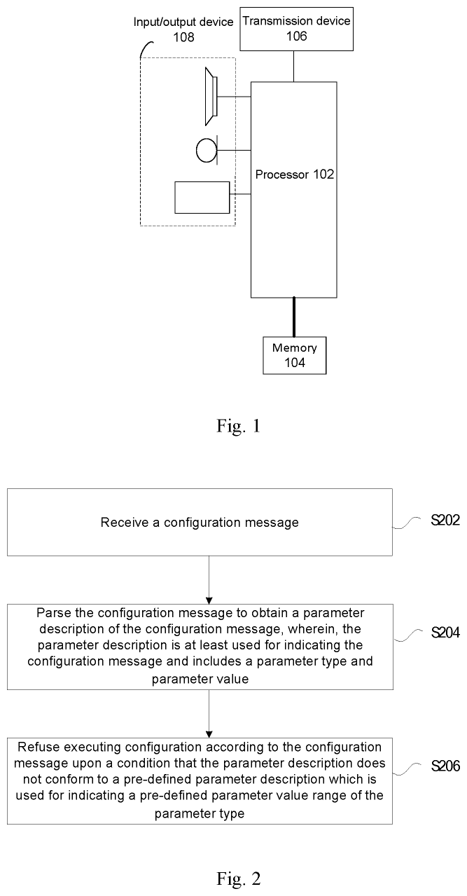

The method embodiments provided by the embodiment of this application can be performed in a mobile terminal, a computer terminal or similar arithmetic units. Taking operation on the mobile terminal as an example, FIG. 1 is a hardware structure diagram of a mobile terminal of a configuration method according to an embodiment of the present disclosure. As shown in FIG. 1, the mobile terminal may include one or more (only one is shown in FIG. 1) processors 102 (the processor 102 may include but not limited to a Micro Control Unit (MCU) or a Field Programmable Gate Array (FPGA) or other processing units) and a memory 104 for storing data, where the mobile terminal may include a transmission device 106 for a communication function and input and output device 108. Those ordinarily skilled in the art can understand that the structure shown in FIG. 1 is only schematic and does not limit a structure of the above mobile terminal. For example, the mobile terminal may further include assemblies more or less than assemblies in FIG. 1, or may have configurations different from those shown in FIG. 1.

The memory 104 may be configured to store computer programs such as software programs and modules of application software and computer programs corresponding to the configuration method in the embodiment of the present disclosure, and the processor 102 performs various functional applications and data processing by operating the computer programs stored in the memory 104, thereby realizing the above method. The memory 104 may include a high-speed random access memory and may further include a nonvolatile memory, such as one or more magnetic memories, flash memories or other nonvolatile solid state memories. In some examples, the memory 104 may further include memories which are remotely set relative to the processor 102 and may be connected to a mobile terminal through networks. The examples of the above networks include but not limited to an internet, an intranet, a local area network, a mobile communication network and a combination thereof.

The transmission device 106 is configured to receive or send data through one network. A specific example of the above networks may include a wireless network provided by a communication supplier of the mobile terminal. In one example, the transmission device 106 includes a Network Interface Controller (NIC) which can be connected to other network devices through a base station so as to communicate with the internet. In one example, the transmission device 106 may be a Radio Frequency (RF) module configured to communicate with the internet in a wireless manner.

It needs to be explained that a terminal device in the embodiment may include but not limited to at least one of following mobile phones (e.g., an Android mobile phone and an IOS mobile phone), a notebook computer, a tablet personal computer, a palmtop, Mobile Internet Devices (MID), a PAD, a desktop computer and Internet of Things devices (e.g., a smart home device and a smart vehicle terminal). The above networks may include but not limited to wired networks and wireless networks, where, the wireless networks include the local area network, a metropolitan area network and a wide area network, and the wireless networks include Bluetooth, WIFI and other networks for realizing wireless communication.

The embodiment provides a configuration method operating on the above terminal. FIG. 2 is a flowchart of a configuration method according to an embodiment of the present disclosure. As shown in FIG. 2, the process includes following steps:

S202: Receive a configuration message.

S204: Parse the configuration message to obtain a parameter description of the configuration message, wherein, the parameter description is at least used for indicating the configuration message and includes a parameter type and parameter value.

S206: Refuse executing configuration according to the configuration message upon a condition that the parameter description does not conform to a pre-defined parameter description which is used for indicating a pre-defined parameter value range of the parameter type.

Wherein, an executive body of the above steps may be but not limited to the terminal, etc.

According to the embodiment of the present disclosure, the configuration message is received and parsed to obtain the parameter description of the configuration message, where the parameter description is at least used for indicating the configuration message and includes the parameter type and the parameter value; and configuration according to the configuration message is refused if the parameter description does not conform to the pre-defined parameter description, where the pre-defined parameter description is used for indicating the pre-defined parameter value range of the parameter type. Namely, after the configuration message is received, whether the parameter description of the configuration message is a standard parameter description or not is parsed and determined so as to determine whether the configuration message is in a standard command format or not, if not, executing the configuration message can be refused, and thus, a problem that there is no solution about how to process non-standard commands for the terminal in the related technologies, and the non-standard commands possibly cause abnormality of the terminal can be solved, thereby achieving a technical effect of preventing abnormality of the terminal.

In an exemplary implementation mode, a configuration message is used for indicating which parameters need to be configured to a terminal and which values the parameters need to be configured. A specific content of the configuration message may be embodied through the parameter type and the parameter value. When configuration is executed, the terminal may be configured according to the parameter type and the parameter value indicated in the configuration message.

In an embodiment, after the configuration message is received, the method further includes: execute configuration according to the configuration message; and re-execute configuration according to a pre-defined default parameter description upon a condition that the terminal enters an abnormal state after configuration is executed, where the default parameter description includes a default parameter type and a default parameter value.

In an exemplary implementation mode, the abnormal state may refer to an abnormal work state of a terminal. For example, the terminal enters a no service state in which a user cannot perform voice call and data service, or the terminal enters a disordered function state due to executing error configuration, or a function logic error state. If the terminal enters the abnormal state, the terminal needs to be recovered to a normal state. Re-configuration is needed according to the default parameter description so that the terminal can be recovered to the normal state, thereby not influencing normal functions of the terminal.

In an embodiment, the method further includes: abandon a configuration message if a parameter description conforms to a pre-defined error parameter description. It needs to be explained that if the parameter description conforms to the pre-defined error parameter description, it indicates that the configuration message is wrong, which cannot be executed and meanwhile needs to be abandoned, thereby preventing causing adverse effects on terminal configuration.

In an embodiment, the configuration message is an OMACP message. The parameter type may be a parm name in the OMACP message.

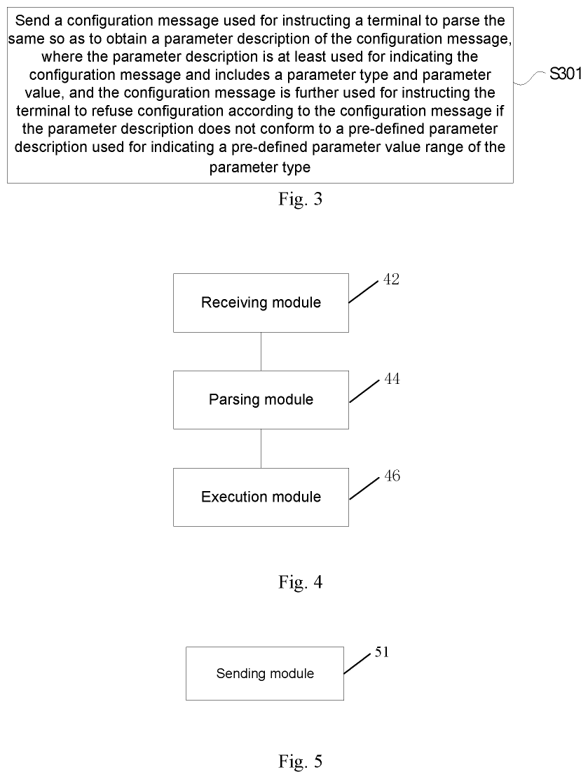

Another embodiment of the present disclosure further provides a configuration method operating on the above server side. FIG. 3 is a flowchart of configuration according to another embodiment of the present disclosure. As shown in FIG. 3, the process includes following steps:

S301: Send a configuration message used for instructing a terminal to parse the same so as to obtain a parameter description of the configuration message, where the parameter description is at least used for indicating the configuration message and includes a parameter type and parameter value, and the configuration message is further used for instructing the terminal to refuse configuration according to the configuration message if the parameter description does not conform to a pre-defined parameter description used for indicating a pre-defined parameter value range of the parameter type.

According to the embodiment of the present disclosure, the configuration message is sent so as to instruct the terminal to receive and parse the same to obtain the parameter description of the configuration message; and configuration according to the configuration message is refused if the parameter description does not conform to the pre-defined parameter description. Namely, after the terminal is instructed to parse and determine whether the parameter description of the configuration message is a standard parameter description or not so as to determine whether the configuration message is in a standard command format or not, if not, executing the configuration message can be refused, and thus, a problem that there is no solution about how to process non-standard commands for the terminal in the related technologies, and the non-standard commands possibly cause abnormality of the terminal can be solved, thereby achieving a technical effect of preventing abnormality of the terminal.

The server side in the embodiment may be a single server, or a server cluster composed of a plurality of servers, or a cloud server.

In an embodiment, after the configuration message is used for instructing the terminal to receive the same, configuration is executed according to the configuration message; and if the terminal enters an abnormal state after configuration is executed, configuration is executed again according to a pre-defined default parameter description which includes a default parameter type and default parameter value.

In an embodiment, the configuration message is further used for instructing the terminal to abandon the configuration message if the parameter description conforms to a pre-defined error parameter description.

In an embodiment, the sending a configuration message includes sending the configuration message to the terminal, or sending the configuration message to a proxy gateway so as to instruct the proxy gateway to forward the configuration message to the terminal.

In an embodiment, the configuration message is an OMACP message. The parameter type may be a parm name in the OMACP message.

The embodiment further provides a terminal configured to realize the embodiments and the preferred implementation modes of the above configuration method, which are not repeated due to previous introduction. The term ‘module’ used as below can realize combination of software and/or hardware with preset functions. Apparatuses described by the following embodiments are preferably realized by the software, but it is possible and conceivable for realizing the apparatuses through the hardware or combination of the software and the hardware.

FIG. 4 is a structure diagram of a terminal according to the embodiment of the present disclosure. As shown in FIG. 4, the apparatus includes:

a Receiving module 42 configured to receive a configuration message;

an parsing module 44 configured to parse the configuration message to obtain a parameter description of the configuration message, where, the parameter description is at least used for indicating the configuration message and includes a parameter type and parameter value; and an Execution module 46 configured to refuse configuration according to the configuration message if the parameter description does not conform to a pre-defined parameter description which is used for indicating a pre-defined parameter value range of the parameter type.

According to the embodiment of the present disclosure, the configuration message is received and parsed to obtain the parameter description of the configuration message, where the parameter description is at least used for indicating the configuration message and includes the parameter type and the parameter value; and configuration according to the configuration message is refused if the parameter description does not conform to the pre-defined parameter description, where the pre-defined parameter description is used for indicating the pre-defined parameter value range of the parameter type. Namely, after the configuration message is received, whether the parameter description of the configuration message is a standard parameter description or not is parsed and determined so as to determine whether the configuration message is in a standard command format or not, if not, executing the configuration message can be refused, and thus, a problem that there is no solution about how to process non-standard commands for the terminal in the related technologies, and the non-standard commands possibly cause abnormality of the terminal can be solved, thereby achieving a technical effect of preventing abnormality of the terminal.

In an embodiment, the Execution module 46 is further configured to execute configuration according to the configuration message after the configuration message is received; and re-execute configuration according to a pre-defined default parameter description upon a condition that the terminal enters an abnormal state after configuration is executed, where the default parameter description includes a default parameter type and default parameter value.

In an exemplary implementation mode, the abnormal state may refer to an abnormal work state of the terminal. For example, the terminal enters a no service state in which a user cannot perform voice call and data service, or the terminal enters a disordered function state due to executing error configuration, or a function logic error state.

In an embodiment, the terminal further includes: an abandon module configured to abandon a configuration message if a parameter description conforms to a pre-defined error parameter description. It needs to be explained that upon a condition that the parameter description conforms to the pre-defined error parameter description, it indicates that the configuration message is wrong, which cannot be executed and meanwhile needs to be abandoned, thereby preventing causing adverse effects on terminal configuration.

In an embodiment, the configuration message is an OMACP message. The parameter type may be a parm name in the OMACP message.

It needs to be explained that the above modules may be realized through software or hardware, and for the latter, the modules may be realized but not limited to the following mode that the above modules are all located in the same processor; or the above modules are located in different processors correspondingly in the form of any combinations.

The embodiment further provides a server side configured to realize the embodiments and the preferred implementation modes of the above configuration method, which are not repeated due to previous introduction. The term ‘module’ used as below can realize combination of software and/or hardware with preset functions. Apparatuses described by the following embodiments are preferably realized by the software, but it is possible and conceivable for realizing the apparatuses through the hardware or combination of the software and the hardware.

FIG. 5 is a structure diagram of a server side according to the embodiment of the present disclosure. As shown in FIG. 5, the apparatus includes:

a sending module 51 configured to send a configuration message used for instructing a terminal to parse the same so as to obtain a parameter description of the configuration message, where the parameter description is at least used for indicating the configuration message and includes a parameter type and parameter value, and the configuration message is further used for instructing the terminal to refuse configuration according to the configuration message if the parameter description does not conform to a pre-defined parameter description used for indicating a pre-defined parameter value range of the parameter type.

According to the embodiment of the present disclosure, the configuration message is sent so as to instruct the terminal to receive and parse the same to obtain the parameter description of the configuration message; and configuration according to the configuration message is refused if the parameter description does not conform to the pre-defined parameter description. Namely, after the terminal is instructed to parse and determine whether the parameter description of the configuration message is a standard parameter description or not so as to determine whether the configuration message is in a standard command format or not, if not, executing the configuration message can be refused, and thus, a problem that there is no solution about how to process non-standard commands for the terminal in the related technologies, and the non-standard commands possibly cause abnormality of the terminal can be solved, thereby achieving a technical effect of preventing abnormality of the terminal.

In an embodiment, after the configuration message is used for instructing the terminal to receive the same, configuration is executed according to the configuration message; and if the terminal enters an abnormal state after configuration is executed, configuration is executed again according to a pre-defined default parameter description which includes a default parameter type and default parameter value.

In an embodiment, the configuration message is further used for instructing the terminal to abandon the configuration message upon a condition that the parameter description conforms to a pre-defined error parameter description.

In an embodiment, the sending a configuration message includes sending the configuration message to the terminal, or sending the configuration message to a proxy gateway so as to instruct the proxy gateway to forward the configuration message to the terminal.

In an embodiment, the configuration message is an OMACP message. The parameter type may be a parm name in the OMACP message.

It needs to be explained that the above modules can be realized through software or hardware, and for the latter, the modules can be achieved but not limited to the following mode that the above modules are all located in the same processor; or the above modules are located in different processors correspondingly in the form of any combinations.

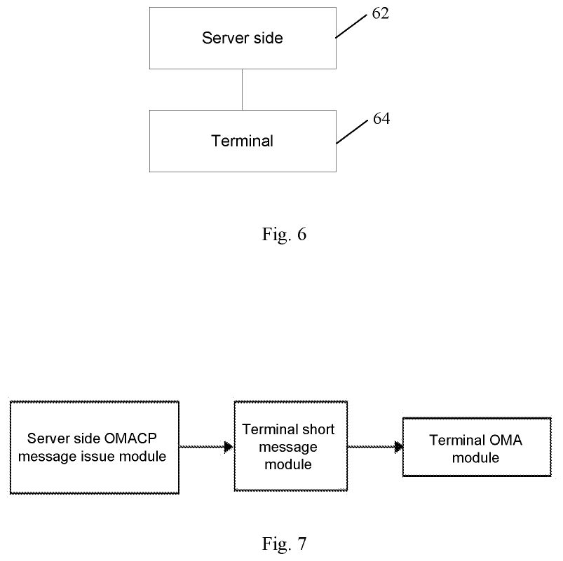

Another embodiment of the present disclosure provides a configuration system. FIG. 6 is a structure diagram of a configuration system according to an exemplary implementation mode of the present disclosure. As shown in FIG. 6, the configuration system of the embodiment includes:

a server side 62 and a terminal 64, where, the server side 62 is configured to send a configuration message;

the terminal 64 is configured to receive the configuration message;

the terminal 64 is further configured to parse the configuration message to obtain a parameter description of the configuration message, and the parameter description is at least used for indicating the configuration message and includes a parameter type and parameter value; and

the terminal 64 is further configured to refuse configuration according to the configuration message if the parameter description does not conform to a pre-defined parameter description which is used for indicating a pre-defined parameter value range of the parameter type.

According to the embodiment of the present disclosure, the configuration message is received and parsed to obtain the parameter description of the configuration message, where the parameter description is at least used for indicating the configuration message and includes the parameter type and the parameter value; and configuration according to the configuration message is refused if the parameter description does not conform to the pre-defined parameter description, where the pre-defined parameter description is used for indicating the pre-defined parameter value range of the parameter type. Namely, after the configuration message is received, whether the parameter description of the configuration message is a standard parameter description or not is parsed and determined so as to determine whether the configuration message is in a standard command format or not, if not, executing the configuration message can be refused, and thus, a problem that there is no solution about how to process non-standard commands for the terminal in the related technologies, and the non-standard commands possibly cause abnormality of the terminal can be solved, thereby achieving a technical effect of preventing abnormality of the terminal.

Other implementation modes of the embodiment refer to implementation modes of the above server side and the terminal, which are not repeated.

By describing the above implementation modes, those skilled in the art can clearly know that the method according to the above embodiments can be realized by means of the software and necessary universal hardware platforms and also can be realized through the hardware, but the former is the better implementation mode under many situations. Based on the understanding, a technical solution of the present disclosure essentially or parts making contribution to the related technologies may be embodied in a software product form. A computer software product is stored in a storage medium (e.g., a ROM/RAM, a disk and a light disk), which includes a plurality of instructions enabling one terminal device (a mobile phone, or a computer, or a server or a network device, etc.) to execute the method according to various embodiments of the present disclosure.

Exemplary Implementation Mode

Open Mobile Alliance (OMA) Client Provisioning (OMACP) mainly provides configuration modification requests related to Access Point Name (APN) updating to a server side in forms such as short messages and Over-The-Air (OTA). The server side (namely, a mobile operator) can conveniently grasp a service condition of a user terminal and modifies important system configuration parameters at any time. Meanwhile, terminal version upgrade becomes more convenient and safer, which avoids risks and expenditure possibly caused by self-upgrade of a user.

The OMACP not only manages mobile devices such as a mobile phone. Along with rise of the Internet of Things, an OMACP server can manage, by a gateway operating the OMACP, smart and non-smart devices under the jurisdiction of the gateway, and typical application scenes include a smart vehicle system and a smart home system.

The OMACP serving as a standard protocol defines how the server interacts with the terminal. By using OMACP, the operator can configure core connection settings and application settings on the devices, such as picture messages, E-mails and data flow; and the OMACP is a first-generation device management technology, which only allows one-way communication: pushing settings to a client side from the server and finding current device states before and after events happen without any form of device inquiries.

The OMACP defines a basic format of OMACP messages during interaction of the server side and the terminal, but does not define a range value of each field in OMACP message bodies, which possibly causes abnormality of the terminal device. For example, the server often issues some non-standard commands which cannot be processed by the terminal. Commands issued by the server have correct formats sometimes, but will cause that the terminal cannot work.

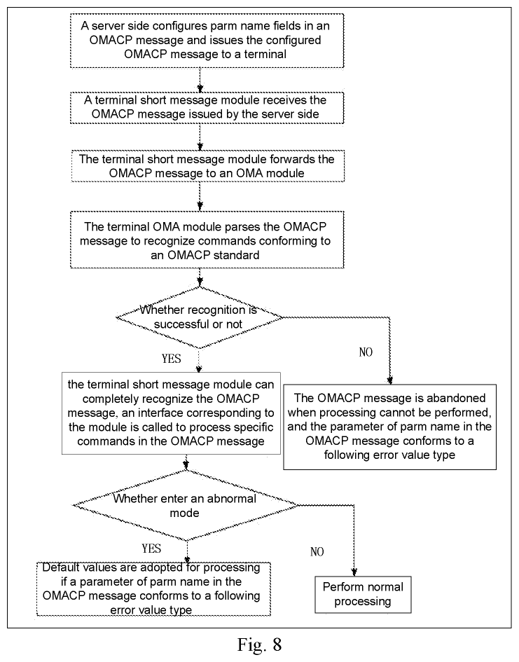

The embodiment provides a configuration method. FIG. 7 is a structure diagram of server side and terminal interaction according to an exemplary implementation mode of the present disclosure. FIG. 8 is a schematic flowchart of a configuration method according to an exemplary implementation mode of the present disclosure. As shown in FIG. 8, the configuration method includes:

receive, by a terminal, an OMACP message (equivalent to a configuration message in the above embodiments) issued by a server side and trigger an analysis command, where it needs to be explained that as shown in FIG. 7, the OMACP message can be issued by an OMACP message issue module at the server side, and the terminal receives the OMACP message by a terminal short message module.

According to the analysis command, an OMACP protocol stack parses the OMACP message to acquire a parameter type and parameter value of the OMACP message, and parameters are used for configuring the terminal. It needs to be explained that as shown in FIG. 7, the OMACP protocol stack parses the OMACP message through a terminal OMA module.

Then, the terminal determines whether to process the type of OMACP message or not according to the parsed parameter type and the parsed parameter value range; if yes, configuration is executed according to the OMACP message; and if not, configuration according to the OMACP message is refused. It needs to be explained that the terminal can determine whether to process the type of OMACP message or not by judging whether the parameter type is a pre-defined parameter type or not and whether the parameter value range is within a pre-defined value range or not; and if the parameter type is the pre-defined parameter type and the parameter value range is within the pre-defined value range, it indicates that the terminal can process the OMACP message.

In an exemplary implementation mode, if it is determined that the terminal cannot process the type of OMACP message and a parameter of parm name in the OMACP message conforms to a pre-defined error value type, the OMACP message is abandoned.

If the terminal cannot work after processing the type of OMACP message, such as in a no service state, the user cannot perform voice call and data service, then, default values are used for processing, and namely, the default values are used for re-configuring the terminal so that the terminal can be recovered to a normal state;

or, if the terminal cannot work after processing the type of OMACP message and the parameter of parm name in the OMACP message conforms to the pre-defined error value type, the default values are used for processing, and namely, the default values are used for re-configuring the terminal so that the terminal can be recovered to the normal state.

The embodiment can avoid function abnormality of the terminal due to abnormal instructions of the server, and can improve user experience.

A configuration method provided by the embodiment is as below:

a sever side configures parm name fields in an OMACP message and issues the configured OMACP message to a terminal; and

the terminal receives and parses the OMACP message to acquire a parm name type in the OMACP message.

In an exemplary implementation mode, the step that a sever side configures parm name fields in an OMACP message includes: perform, by the server side, message type (a parameter type of the OMACP message) description on reserved fields in parm name of the OMACP message and mark the message type and the parm name fields one by one.

In an exemplary implementation mode, the step that a sever side issues a configured OMACP notification message to a terminal includes: issue, by the server side, the configured OMACP message to a sending proxy gateway of the server side, and then send, by the sending proxy gateway, the OMACP message to the terminal.

In an exemplary implementation mode, the step that a terminal receives and parses an OMACP message to acquire a parameter type in the OMACP message includes:

receive, by the terminal, the OMACP message, and trigger an analysis command;

according to the analysis command, parse, by an OMACP protocol stack, the OMACP message to acquire the parameter type.

If the terminal cannot process the type of OMACP message and a parameter of parm name in the OMACP message conforms to a following error value type, the OMACP message is abandoned:

<characteristic type=“APPLICATION”>

<parm name=“reserved” value=“ignore”/>

</characteristic>.

If the terminal cannot work after processing the type of OMACP message, such as in a no service state, a user cannot perform voice call and data service. In addition, if the parameter of parm name in the OMACP message conforms to a following error value type, default values are adopted for processing:

<characteristic type=“APPLICATION”>

<parm name=“reserved” value=“default”/>

</characteristic>.

It needs to be explained that the terminal has processed the message and enters the no service state, an OMA module uses the default values for execution again at the time, and thus a mobile phone can be recovered to a normal service state.

The embodiment further provides a server side and terminal communication system based on OMACP, which includes:

a sever side configured to configure parm name fields in an OMACP message and issue the configured OMACP message to a terminal; and the terminal configured to receive and parse the OMACP message to acquire a parm name type in the OMACP message.

The server side is further configured to: perform message type description on reserved fields in parm name of the OMACP message and mark the message type and the parm name fields one by one.

The server side is further configured to: issue the configured OMACP message to a sending proxy gateway of the server side, and then send, by the sending proxy gateway, the OMACP message to the terminal.

The terminal is further configured to: receive the OMACP message, and trigger an OMACP protocol stack to parse the OMACP message to acquire a parameter type.

If the terminal cannot process the type of OMACP message and a parameter of parm name in the OMACP message conforms to a following error value type, the OMACP message is abandoned:

<characteristic type=“APPLICATION”>

<parm name=“reserved” value=“ignore”/>

</characteristic>.

If the terminal cannot work after processing the type of OMACP message, such as in a no service state, a user cannot perform voice call and data service. In addition, if the parameter of parm name in the OMACP message conforms to a following error value type, default values are adopted for processing:

<characteristic type=“APPLICATION”>

<parm name=“reserved” value=“default”/>

</characteristic>.

The embodiment of the present disclosure further provides a computer-readable storage medium storing computer programs, where the computer programs are configured to execute steps in any above method embodiment when operated.

In an exemplary embodiment, the above computer-readable storage medium may include but not limited to a U disk, a Read-Only Memory (ROM), a Random Access Memory (RAM), a mobile hard disk, a magnetic disk or a light disk or other media capable of storing the computer programs.

The embodiment of the present disclosure further provides an electronic device including a memory and a processor, where the memory stores computer programs, and the processor is configured to operate the computer programs so as to execute steps in any above method embodiment.

In an exemplary embodiment, an electronic device may further include a transmission device and an input and output device, where the transmission device is connected to the processor, and the input and output device is connected to the processor.

Specific examples in the embodiment can refer to the examples described in the above embodiments and the exemplary implementation modes, so that the embodiment is not repeated herein.

Obviously, those skilled in the art should understand that the modules or the steps in the present disclosure can be realized through a universal computing device, can be centralized in the single computing device or distributed in a network formed by a plurality of computing devices and can be realized by program codes capable of being executed by the computing device so that the modules or the steps can be stored in a storage unit to be executed by the computing device; and the shown or described steps can be executed in sequence different from the sequence herein under some situations, or the modules and steps can be made into various integrated circuit modules, or more of the modules or the steps can be made into single integrated circuit modules to be realized. Thus, the present disclosure is not limited to any specific hardware and software combination.

The above embodiments are merely preferable embodiments of the present disclosure but are not used for limiting the present disclosure, and the present disclosure may be variously modified and changed for those skilled in the art. Any modification, equivalent replacement, improvement, etc., made within the principle of the present disclosure shall fall within the scope of protection of the present disclosure.

### INDUSTRIAL APPLICABILITY

In the embodiment of the present disclosure, the configuration message is received and parsed to obtain the parameter description of the configuration message, where the parameter description is at least used for indicating the configuration message and includes the parameter type and the parameter value; and configuration according to the configuration message is refused if the parameter description does not conform to the pre-defined parameter description, where the pre-defined parameter description is used for indicating the pre-defined parameter value range of the parameter type. Namely, after the configuration message is received, whether the parameter description of the configuration message is a standard parameter description or not is parsed and determined so as to determine whether the configuration message is in a standard command format or not, if not, executing the configuration message can be refused, and thus, a problem that there is no solution about how to process non-standard commands for the terminal in the related technologies, and the non-standard commands possibly cause abnormality of the terminal can be solved, thereby achieving a technical effect of preventing abnormality of the terminal.

1. A configuration method, applied to a terminal, comprising
receiving a configuration message;
parsing the configuration message to obtain a parameter description of the configuration message, wherein the parameter description is at least used for indicating the configuration message and comprises a parameter type and parameter value; and
refusing executing configuration according to the configuration message upon a condition that the parameter description does not conform to a pre-defined parameter description which is used for indicating a pre-defined parameter value range of the parameter type.

2. The method according to claim 1, wherein after the configuration message is received, the method further comprises:
executing the configuration according to the configuration message; and
re-executing the configuration according to a pre-defined default parameter description upon a condition that the terminal enters an abnormal state after the configuration, wherein the default parameter description comprises a default parameter type and a default parameter value.

3. The method according to claim 1, further comprising:
discarding the configuration message upon a condition that the parameter description conforms to a pre-defined error parameter description.

4. The method according to claim 1, wherein the configuration message is a Open Mobile Alliance Client Provisioning (OMACP) message.

5. A configuration method, applied to a server side, comprising
sending a configuration message, wherein the configuration message is used for instructing a terminal to parse the configuration message to obtain a parameter description of the configuration message, the parameter description is at least used for indicating the configuration message and comprises a parameter type and a parameter value, and the configuration message is further used for instructing the terminal to refuse executing configuration according to the configuration message upon a condition that the parameter description does not conform to a pre-defined parameter description used for indicating a pre-defined parameter value range of the parameter type.

6. The method according to claim 5, wherein the configuration message is further used for instructing the terminal to execute configuration according to the configuration message after the configuration message is received; and the configuration is re-executed according to a pre-defined default parameter description upon a condition that the terminal enters an abnormal state after configuration, wherein the default parameter description comprises a default parameter type and a default parameter value.

7. The method according to claim 5, wherein the configuration message is further used for instructing the terminal to discard the configuration message upon a condition that the parameter description conforms to a pre-defined error parameter description.

8. The method according to claim 5, wherein the sending a configuration message comprises:
sending the configuration message to the terminal, or
sending the configuration message to a proxy gateway so as to instruct the proxy gateway to forward the configuration message to the terminal.

9. A terminal, comprising a processor coupled with a memory, and the processor is configured to:
receive a configuration message;
parse the configuration message to obtain a parameter description of the configuration message, wherein the parameter description is at least used for indicating the configuration message and comprises a parameter type and parameter value; and
refuse executing configuration according to the configuration message upon a condition that the parameter description does not conform to a pre-defined parameter description which is used for indicating a pre-defined parameter value range of the parameter type.

10. (canceled)

11. (canceled)

12. A non-transitory computer-readable storage medium, storing a computer program, when the computer program is executed by a processor, to cause the processor to perform the method as claimed in claim 1.

13. An electronic device, comprising a memory and a processor, wherein the memory stores a computer program, and the processor is configured to execute the computer program to perform the method as claimed in claim 1.

14. An electronic device, comprising a memory and a processor, wherein the memory stores a computer program, and the processor is configured to execute the computer program to perform the method as claimed in claim 2.

15. An electronic device, comprising a memory and a processor, wherein the memory stores a computer program, and the processor is configured to execute the computer program to perform the method as claimed in claim 3.

16. An electronic device, comprising a memory and a processor, wherein the memory stores a computer program, and the processor is configured to execute the computer program to perform the method as claimed in claim 4.

17. An electronic device, comprising a memory and a processor, wherein the memory stores a computer program, and the processor is configured to execute the computer program to perform the method as claimed in claim 5.

18. An electronic device, comprising a memory and a processor, wherein the memory stores a computer program, and the processor is configured to execute the computer program to perform the method as claimed in claim 6.

19. An electronic device, comprising a memory and a processor, wherein the memory stores a computer program, and the processor is configured to execute the computer program to perform the method as claimed in claim 7.

20. An electronic device, comprising a memory and a processor, wherein the memory stores a computer program, and the processor is configured to execute the computer program to perform the method as claimed in claim 8.

21. A non-transitory computer-readable storage medium, storing a computer program, when the computer program is executed by a processor, to cause the processor to perform the method as claimed in claim 2.

22. A non-transitory computer-readable storage medium, storing a computer program, when the computer program is executed by a processor, to cause the processor to perform the method as claimed in claim 5.
